(19) United States
(12) Patent Application Publication
(10) Pub. No.: US 2023/0193171 A1
(43) Pub. Date: Jun. 22, 2023

(54) FLAVOUR

(71) Applicant: Givaudan SA, VERNIER (CH)

(72) Inventors: Chisato MAYAMA, Tokyo (JP); Hiroaki KUDO, Tokyo (JP); Yohei MIYAMOTO, Tokyo (JP)

(21) Appl. No.: 17/997,773

(22) PCT Filed: May 11, 2021
(86) PCT No.: PCT/EP2021/062452

§ 371 Date: Nov. 2, 2022

(30) Foreign Application Priority Data
May 14, 2020 (GB) 2007141.1

(51) Int. Cl. C12C 5/02; A23L 2/56

(52) U.S. Cl. CPC C12C 5/026; A23L 2/56

(57) ABSTRACT

A beer beverage comprising 4-vinyl phenol (4VP) and 4-vinyl guaiacol (4VG) in the 4VG:4VP weight ratio of from 2.5-10, the overall weight proportion of 4VG and 4VP in the beverage being from 0.1 ppm to 0.6 ppm.

The compounds provide desirable beer flavor characteristics to both beers and non-alcoholic beer beverages deficient in these characteristics.

This disclosure relates to beer and beer-tasting non-alcoholic beverages, and to the improvement of the taste of such beverages.

Beer is an alcoholic beverage brewed from cereal grains and has been known and appreciated from antiquity. Its particular taste qualities, particularly the distinct bitterness and maltiness, are so desirable that it has been sought to replicate these taste characteristics in non-alcoholic beer beverages. In addition, it is desirable to enhance the characteristics in beers and beer beverages that are inherently lacking in these qualities. Both brewed beer and beverages that seek to emulate beer flavor shall hereinafter be described as “beer beverages”.

It has now been found that it is possible to enhance the desirable flavor qualities of beer beverages. There is therefore provided a beer beverage comprising 4-vinyl phenol (4VP) and 4-vinyl guaiacol (4VG) in the 4VG:4VP weight ratio of from 2.5-10, the overall weight proportion of 4VG and 4VP in the beverage being from 0.11 ppm to 0.56 ppm.

There is further provided a method of conferring desirable beer-taste characteristics on a beer beverage, comprising the addition to the beverage of 4-vinyl phenol (4VP) and 4-vinyl guaiacol (4VG) in the 4VG:4VP weight ratio of from 2.5-10, the overall weight proportion of 4VG and 4VP in the beverage being from 0.1 ppm to 0.6 ppm.

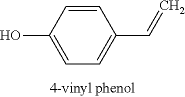

is a phenolic compound found in wine and beer. It is produced by the action of the yeast Brettanomyces, and is said to confer on wine aromas described as “barnyard”, “medicinal” and “mousy”.

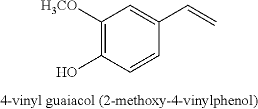

is found in distilled drinks such as whisk(e)y and rum, where it confers sweet, smoky background notes.

Both have been used in various flavouring applications, including in alcoholic beverages. However, it is not previously been recognized that the use of both together in a particular ratio can contribute desirable beer flavor characteristics, characterized as “malty” and “thick”.

In a particular embodiment, the weight ratio of 4VG:4VP is from 4-6.

In a further particular embodiment, the overall weight proportion of 4VG and 4VP in the beverage is from 0.11 ppm to 0.56 ppm, more particularly from 0.22 ppm to 0.28 ppm.

4VP and 4VG may be added to a beverage by simply adding the compounds either mixed or separate and stirring them in.

The disclosure is further described with reference to the following examples, which depict particular embodiments, and which are not intended to be in any way limiting.

### EXAMPLES

### Example 1

A number of different ratios of 4VG and 4VP were added to samples of non-alcoholic beer-tasting drinks. The drinks used were “Kachipla” (ex Amazon Japan) and “Ryoma 1865” (ex Nippon Beer Co., Japan).

200 g samples of each drink were diluted by addition of 800 g carbonated water, providing a carbonated beverage with a malty taste. The proportions of 4VG and 4VP shown in the table below were added.

The samples were then tested by 4 expert taste panelists in comparison with diluted samples of the drinks that lacked the addition of 4VG and 4VP. The results are shown in the following table.

| | 4VG | 4VP | | |
|---|---|---|---|---|
| Sample | content | content | 4VG:4VP | |
| No. | (ppm) | (ppm) | ratio | Taste characteristics |
| 1 | 0.2 | 0 | infinity | Slightly malty, medicinal, sour, |
| | | | | light |
| 2 | 0.2 | 0.005 | 40 | Slightly malty, medicinal, light, |
| | | | | sharp |
| 3 | 0.2 | 0.01 | 20 | Malty, slightly salty |
| 4 | 0.2 | 0.02 | 10 | Malty |
| 5 | 0.2 | 0.04 | 5 | Very malty and tasty, thick, |
| | | | | body, beer-like, meaty, |
| 6 | 0.2 | 0.08 | 2.5 | Very malty, but slightly too |
| | | | | heavy |
| 7 | 0.2 | 0.2 | 1 | Malty, but too heavy |
| 8 | 0.1 | 0.02 | 5 | Light, drinkable, malty, good |
| | | | | CO₂ sensation, slightly sour |
| 9 | 0.4 | 0.08 | 5 | Malty, thick, slightly salty |
| 10 | 0.9 | 0.16 | 5 | Whiskey-like, medicinal |

The desirable characteristics provided by particular quantities and proportions of 4VG and 4VP can clearly be seen.

### Example 2

The Example 1 procedure was repeated with carbonated water. The results, in comparison with an untreated sample of water, were as follows:

| | 4VG | 4VP | | |
|---|---|---|---|---|
| Sample | content | content | 4VG:4VP | |
| No. | (ppm) | (ppm) | ratio | Taste characteristics |
| 11 | 0.1 | 0.02 | 5 | light, thin, slightly phenolic |
| 12 | 0.2 | 0.04 | 5 | beer-like, meaty, good CO2 |
| | | | | sensation |
| 13 | 0.4 | 0.08 | 5 | medicinal |
| 14 | 0.8 | 0.16 | 5 | whiskey-like, medicinal |

Again the addition of the appropriate proportions of 4VGT and 4VP provided a desirable beer-like flavour.

1. A beer beverage comprising 4-vinyl phenol (4VP) and 4-vinyl guaiacol (4VG) in a 4VG:4VP weight ratio of from 2.5-10, wherein the amount of 4VG and 4VP in the beverage comprises from 0.1 ppm to 0.6 ppm.

2. The beer beverage according to claim 1, wherein the 4VG:4VP weight ratio is from 4-6.

3. The beer beverage according to claim 1, wherein the amount of 4VG and 4VP in the beverage is from 0.11 ppm to 0.56 ppm.

4. The beer beverage according to claim 3, wherein the amount of 4VG and 4VP in the beverage is from 0.22 ppm to 0.28 ppm.

5. A method of conferring desirable beer-taste characteristics in a beer beverage, comprising adding to the beverage 4-vinyl phenol (4VP) and 4-vinyl guaiacol (4VG) in a 4VG:4VP weight ratio of from 2.5-10, wherein the amount of 4VG and 4VP in the beverage comprises from 0.1 ppm to 0.6 ppm.

6. The method according to claim 5, wherein the 4VG:4VP weight ratio is from 4-6.

7. The method according to claim 5, wherein the amount of 4VG and 4VP in the beverage is from 0.11 ppm to 0.56 ppm.

8. The method according to claim 7, wherein the amount of 4VG and 4VP in the beverage is from 0.22 ppm to 0.28 ppm.

9. The beer beverage according to claim 1, wherein the beer beverage is alcoholic.

10. The beer beverage according to claim 1, wherein the beer beverage is non-alcoholic.
